(19) United States
(12) Patent Application Publication
(10) Pub. No.: US 2021/0067041 A1
(43) Pub. Date: Mar. 4, 2021

(54) BUCK CONVERTER INCLUDING INDUCTOR CURRENT SENSING VIA HIGH- AND LOW-SIDE SWITCHING DEVICE CURRENT SENSING

(71) Applicant: QUALCOMM Incorporated, San Diego, CA (US)

(72) Inventors: Kunhee CHO, Royersford, PA (US); Sanghwa JUNG, Los Gatos, CA (US); Zhaohui ZHU, San Jose, CA (US); Chunping SONG, Palo Alto, CA (US)

(21) Appl. No.: 16/894,491

(22) Filed: Jun. 5, 2020

Related U.S. Application Data
(60) Provisional application No. 62/893,700, filed on Aug. 29, 2019.

(51) Int. Cl. H02M 3/158

(52) U.S. Cl. CPC H02M 3/1582; H02M 2003/1586; H02M 3/1584

(57) ABSTRACT

An apparatus for generating an output voltage across a load. The apparatus includes a first switching device; a second switching device coupled in series with the first switching device between an upper voltage rail and a lower voltage rail, wherein the upper voltage rail is configured to receive an input voltage; an inductor between a node between the first and second switching device and the load; a sensor configured to generate a control signal related to a current through the inductor; and a controller configured to operate the first and second switching devices to generate the output voltage based on the control signal.

### CROSS-REFERENCE TO RELATED APPLICATION

This application claims priority to Provisional Application Ser. No. 62/893,700, filed on Aug. 29, 2019, which is incorporated herein by reference.

### FIELD

Aspects of the present disclosure relate generally to switched-mode power supply, such as direct current (DC)-to-DC converters, and in particular, to a Buck converter including inductor current sensing by sensing individual currents of the high-side switching device and low-side switching device, and combine the individual currents to generate a current related to the inductor current.

### DESCRIPTION OF RELATED ART

Switched-mode power supplies, such as direct current (DC)-to-DC converters, and more specifically, Buck converters, convert an input voltage into an output voltage using switching devices that are operated (e.g., turned on and off) at high frequencies, and use inductors and/or capacitors to generate and regulate an output voltage for a load (e.g., a battery). Operating the switching devices in order to regulate the output voltage often entails measuring the current provided to the load. The measured current may be used to regulate the output voltage and also provide overcurrent protection.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the disclosure relates to an apparatus for generating an output voltage across a load. The apparatus includes a first charger including a first switching device; a second switching device coupled in series with the first switching device between an upper voltage rail and a lower voltage rail, wherein the upper voltage rail is configured to receive an input voltage; a first inductor coupled between a node between the first and second switching devices and the load; a first sensor configured to generate a first control signal related to a current through the first inductor, wherein the first sensor includes a first current sensor configured to generate a first sensed current related to a current through the first switching device, a second current sensor configured to generate a second sensed current related to a current through the second switching device, and a first summer configured to sum the first and second sensed currents to generate the first control signal; and at least one controller configured to operate the first and second switching devices to generate the output voltage based on the first control signal.

Another aspect of the disclosure relates to a method for generating an output voltage across a load. The method includes sensing a current through a first inductor, including sensing a first current through a first switching device, sensing a second current through a second switching device, and summing the first and second sensed currents to generate the sensed current through the first inductor; and operating the first switching device and the second switching device to generate the output voltage based on the sensing of the current through the first inductor.

Another aspect of the disclosure relates to an apparatus for generating an output voltage across a load. The apparatus includes means for sensing a current through a first inductor, including means for sensing a first current through the first switching device, means for sensing a second current through the second switching device, and means for summing the first and second sensed currents to generate the sensed current through the first inductor; and means for operating first and second switching devices to generate the output voltage based on the sensing of the current through the first inductor.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1 illustrates a schematic diagram of an exemplary Buck converter in accordance with an aspect of the disclosure.

FIG. 2A illustrates a timing diagram of an exemplary switching mode operation of the Buck converter of FIG. 1 in accordance with another aspect of the disclosure.

FIG. 2B illustrates a timing diagram of another exemplary switching mode operation of the Buck converter of FIG. 1 in accordance with another aspect of the disclosure.

FIG. 3A illustrates a schematic diagram of another exemplary Buck converter in accordance with another aspect of the disclosure.

FIG. 3B illustrates a timing diagram of an exemplary operation of the Buck converter of FIG. 3A in accordance with another aspect of the disclosure.

FIG. 4 illustrates a schematic diagram of an exemplary two-level Buck converter including master and slave chargers for a battery and a load in accordance with another aspect of the disclosure.

FIG. 5A illustrates a schematic diagram of another exemplary three-level Buck converter including master and slave chargers for a battery and a load in accordance with another aspect of the disclosure.

FIG. 5B illustrates a schematic diagram of another exemplary three-level Buck converter including a slave charger control for a load (e.g., a battery) in accordance with another aspect of the disclosure.

FIG. 6A illustrates a schematic diagram of another exemplary three-level Buck converter with high-side and low-side switching devices current sensing in accordance with another aspect of the disclosure.

FIG. 6B illustrates a schematic diagram of another exemplary three-level Buck converter with high-side and low-side switching devices current sensing in accordance with another aspect of the disclosure.

FIG. 7 illustrates a schematic diagram of another exemplary two-level Buck converter with high-side and low-side switching devices current sensing in accordance with another aspect of the disclosure.

FIG. 8 illustrates a schematic diagram of another exemplary three-level Buck converter in Vₒ/Vᵢₙ<0.5 and Vₒ/Vᵢₙ>0.5 switching modes with high-side and low-side switching devices current sensing in accordance with another aspect of the disclosure.

FIG. 9A illustrates a schematic diagram of an exemplary high-side switching device current sensor for a Buck converter in accordance with another aspect of the disclosure.

FIG. 9B illustrates a schematic diagram of an exemplary low-side switching device current sensor for a Buck converter in accordance with another aspect of the disclosure.

FIG. 10 illustrates a flow diagram of an exemplary method of generating an output voltage across a load in accordance with another aspect of the disclosure.

FIG. 11 illustrates a block diagram of an exemplary wireless device in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

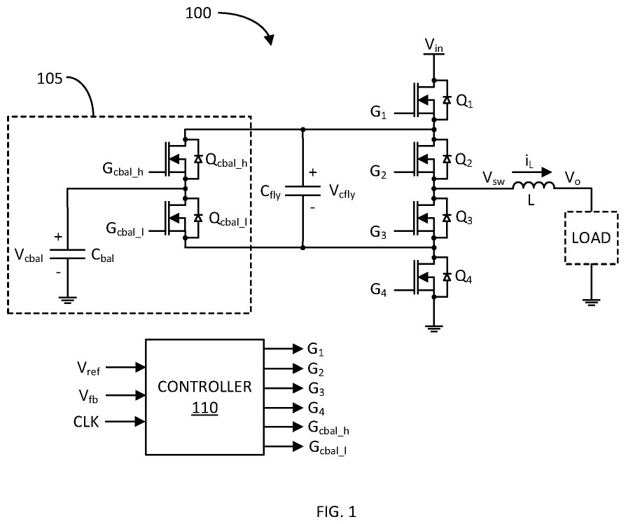

FIG. 1 illustrates a schematic diagram of an exemplary Buck converter 100 in accordance with an aspect of the disclosure. The Buck converter 100 receives an input voltage Vᵢₙ and generates an output voltage Vₒ based on a reference voltage V_{ref} for setting a target voltage for the output voltage Vₒ. That is, the Buck converter 100 controls or regulates the output voltage Vₒ such that the output voltage Vₒ is related to (e.g., by a multiplication factor or being substantially the same as) the reference voltage V_{ref}. The term “substantially the same” means that the voltages or parameters may not be exactly the same but may deviate slightly due to non-ideal behavior (tolerances) of components (e.g., turn on resistance of a switching device, resistance of an inductor, etc.).

In particular, the Buck converter 100 includes a set of switching devices Q₁, Q₂, Q₃, and Q₄ coupled in series (in that order) between an upper voltage rail configured to receive the input voltage Vᵢₙ and a lower voltage rail (e.g., at ground (Gnd) potential). Each of the switching devices Q₁, Q₂, Q₃, and Q₄ may be configured as a transistor, such as a field effect transistor (FET) or a bipolar junction transistor (BJT). For example, each of the switching devices Q₁, Q₂, Q₃, and Q₄ may be configured as an n-channel metal oxide semiconductor (NMOS) FET, a p-channel metal oxide semiconductor (PMOS) FET, a pass gate, a transmission gate, or other type of switching device.

The set of switching devices Q₁, Q₂, Q₃, and Q₄ include a set of control inputs (e.g., gates) configured to receive a set of control signals G₁, G₂, G₃, and G₄, respectively. The set of control signals G₁, G₂, G₃, and G₄ control the on (closed) or off (open) states of the set of switching devices Q₁, Q₂, Q₃, and Q₄, respectively. In the examples used herein, the control signal being at a logic high voltage causes the corresponding switching device to be on, and being at a logic low voltage causes the corresponding switching device to be off. However, it shall be understood that depending on the type of switching device, the control signal may be at a logic low voltage to turn on the corresponding switching device, and may be at a high logic voltage to turn off the corresponding switching device. Also, depending on the type of switching device, each of the control signals G₁, G₂, G₃, and G₄ may be complementary logic signals.

The Buck converter 100 further includes a fly capacitor C_{fly} coupled between a first node between the first and second switching devices Q₁ and Q₂, and a second node between the third and fourth switching devices Q₃ and Q₄. The capacitor C_{fly} is typically referred to as the fly capacitor because it is closest to the upper voltage rail Vᵢₙ compared to a balancing capacitor described herein.

The Buck converter 100 further includes a voltage control circuit 105 for controlling the voltage V_{cfly} across the fly capacitor C_{fly} during operation of the Buck converter (e.g., control the voltage V_{cfly} to a defined voltage of Vᵢₙ/2). The voltage control circuit 105 includes another set of switching devices Q_{cbal_h} and Q_{cbal_l} coupled in series across the fly capacitor C_{fly}. Similar to the switching devices Q₁, Q₂, Q₃, and Q₄, each of the switching devices Q_{cbal_h} and Q_{cbal_l} may be configured as a transistor, such as a FET or derivative thereof (e.g., NMOS FET, PMOS FET, pass gate, transmission gate, etc.) or a BJT. The set of switching devices Q_{cbal_h} and Q_{cbal_l} includes a set of control inputs (e.g., gates) configured to receive a set of control signals G_{cbal_h} and G_{cbal_l}, respectively. Similar to the switching devices Q₁, Q₂, Q₃, and Q₄, the set of control signals G_{cbal_h} and G_{cbal_l} controls the on (closed) and off (open) states of the set of switching devices Q_{cbal_h} and Q_{cbal_l}, respectively. Again, in this example, the control signal being a logic high voltage turns on the corresponding switching device, and being a logic low voltage turns off the corresponding switching device; but may be different as discussed with reference to switching devices Q₁, Q₂, Q₃, and Q₄.

The voltage control circuit 105 further includes a balancing capacitor C_{bal} coupled between a node between the switching devices Q_{cbal_h} and Q_{cbal_l} and the lower voltage rail (e.g., Gnd). The balancing capacitor C_{bal} may be configured to have substantially the same capacitance as the fly capacitor C_{fly}. This is done so that the voltage V_{cfly} across the fly capacitor C_{fly} is substantially the same as the voltage V_{cbal} across the balancing capacitor C_{bal} (e.g., at substantially Vᵢₙ/2), when these capacitors are coupled in series between the upper voltage rail Vin and the lower voltage rail Gnd, when switching devices Q₁ and Q_{cbal_l} are turned on, as discussed in more detail further herein.

The Buck converter 100 further includes a controller 110 configured to generate the set of control signals G₁, G₂, G₃, G₄, G_{cbal_h} and G_{cbal_l} for the set of switching devices Q₁, Q₂, Q₃, Q₄, Q_{cbal_h} and Q_{cbal_l}, respectively, based on the reference voltage V_{ref}, a feedback voltage V_{fb} related to the output voltage Vₒ, and a clock signal CLK. The Buck converter 100 may be operated in a switching mode. Within the switching mode, the reference voltage V_{ref} may dictate whether the Buck converter 100 should operate in a Vₒ/Vᵢₙ<0.5 switching mode or a Vₒ/Vᵢₙ>0.5 switching mode.

For example, if the reference voltage V_{ref} corresponds to an output voltage Vₒ being less than Vᵢₙ/2, the Buck converter 100 may operate in the Vₒ/Vᵢₙ<0.5 switching mode. If the reference voltage V_{ref} corresponds to an output voltage Vₒ being greater than Vᵢₙ/2, the Buck converter 100 may operate in the Vₒ/Vᵢₙ>0.5 switching mode. If the reference voltage V_{ref} corresponds to an output voltage Vₒ being substantially at Vᵢₙ/2, the Buck converter 100 may operate in either the Vₒ/Vᵢₙ<0.5 or Vₒ/Vᵢₙ>0.5 switching mode, or may switch between these modes as needed to maintain the output voltage Vₒ at substantially Vᵢₙ/2.

The Buck converter 100 is configured to generate a switching voltage V_{sw} at a node between switching devices Q₂ and Q₃. The Buck converter 100 further includes an inductor L coupled between the node between the switching devices Q₂ and Q₃ and a load. The load is coupled between the inductor L and the lower voltage rail Gnd. The output voltage Vₒ is generated across the load due to, at least in part, an inductor current i_{L} flowing through the inductor L and into the load.

The derivative or slope of the inductor current i_{L} is a function of the voltage across the inductor L divided by its inductance L (e.g., di/dt=(V_{sw}−Vₒ)/L). Accordingly, the Buck converter 100 controls or regulates of the output voltage Vₒ by controlling the switching voltage V_{sw}. When the switching voltage V_{sw} is higher than the output voltage Vₒ, the slope of the inductor current i_{L} is positive (increasing) to control the output voltage Vₒ. When the switching voltage V_{sw} is lower than the output voltage Vₒ, the slope of the inductor current i_{L} is negative (decreasing) to control the output voltage Vₒ. In switching mode, the switching voltage V_{sw} alternates, in response to a clock signal, between higher and lower than the output voltage Vₒ.

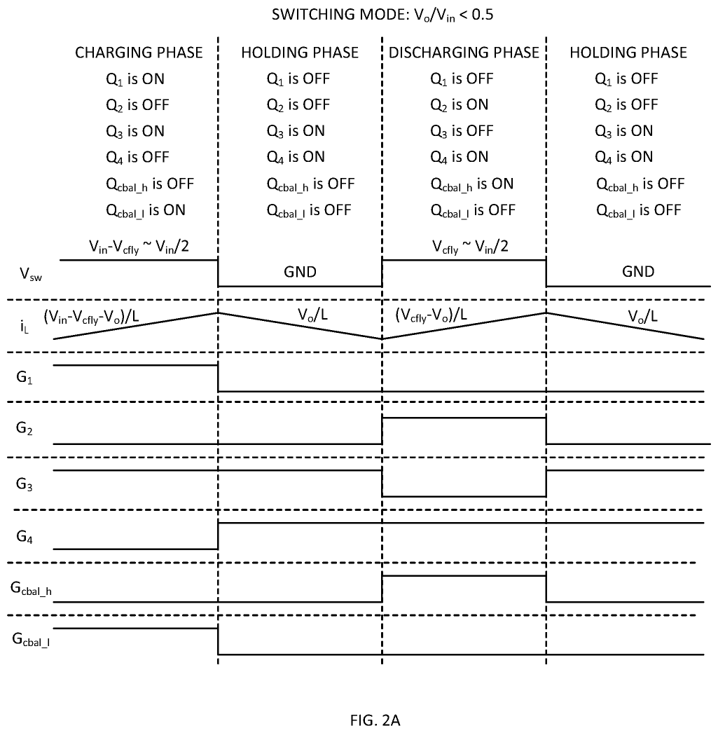

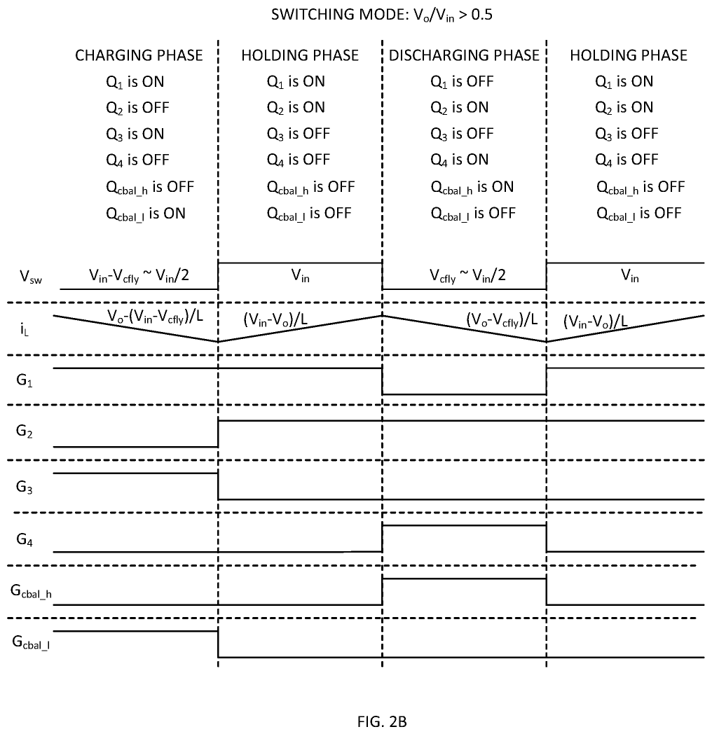

FIG. 2A illustrates a timing diagram of an exemplary switching mode operation of the Buck converter 100 for the case where the ratio of the output voltage Vₒ to the input voltage is less than 0.5 (e.g., Vₒ/Vᵢₙ<0.5) in accordance with another aspect of the disclosure. In the Vₒ/Vᵢₙ<0.5 case, the switching voltage V_{sw} alternates between substantially Vᵢₙ/2 and Gnd in response to phases of the clock signal CLK. The horizontal axis of the timing diagram represents time, and the vertical axes represent different parameters, such as voltage in the case of V_{sw}, current in the case of i_{L}, and logic states in the case of the set of control signals G₁, G₂, G₃, G₄, G_{cbal_h} and G_{cbal_l}.

There are four (4) phases in a complete regulation cycle: (1) a charging phase whose details are depicted in the left-most column of the timing diagram; (2) a first holding phase whose details are depicted in the second column from the left; (3) a discharging phase whose details are depicted in the third column from the left; and (4) a second holding phase whose details are depicted in the right-most column. The duration of each phase may be related to (e.g., a half-period of) the clock signal CLK. The complete regulation cycle is repeated in order to control or regulate the output voltage Vₒ. Note, that the second and fourth phases are the same (both holding phases). Accordingly, there are three (3) distinct phases. Thus, the Buck converter 100 may be referred to as a three-phase or three-level Buck converter.

In the charging phase, the controller 110 configures the set of control signals G₁, G₂, G₃, G₄, G_{cbal_h} and G_{cbal_l} to be at logic high, low, high, low, low, and high states, respectively. Accordingly, in the charging phase, the switching devices Q₁, Q₃, and Q_{cbal_l} are on, and the switching devices Q₂, Q₄, and Q_{cbal_h} are off. In this configuration, the fly capacitor C_{fly} and the balancing capacitor C_{bal} are coupled in series between the upper voltage rail Vin and the lower voltage rail Gnd to establish a current path to charge the capacitors (ergo, the charging phase). The capacitance of the fly and balancing capacitors C_{fly} and C_{bal} may be configured to be substantially the same. Thus, the voltages V_{cfly} and V_{cbal} across the capacitors C_{fly} and C_{bal} are also substantially the same at substantially Vᵢₙ/2 (achieving a balancing of the voltages across the capacitors). Also, in this configuration, the node between the capacitors C_{fly} and C_{bal} is coupled to the node at which the switching voltage V_{sw} is produced via the turned-on switching device Q₃. Thus, the switching voltage V_{sw} is at substantially Vᵢₙ/2. Since, this is the case where Vₒ/Vᵢₙ is less than 0.5, V_{sw} is greater than Vₒ; thereby, the Buck converter 100 produces an inductor current i_{L} with a positive slope of substantially (Vᵢₙ−V_{cfly}−Vₒ)/L.

In the first holding phase, the controller 110 configures the set of control signals G₁, G₂, G₃, G₄, G_{cbal_h} and G_{cbal_l} to be at logic low, low, high, high, low, and low states, respectively. Accordingly, in the first holding phase, the switching devices Q₃ and Q₄ are on, and the switching devices Q₁, Q₂, Q_{cbal_h} and Q_{cbal_l} are off. In this configuration, the node at which the switching voltage V_{sw} is produced is coupled to the lower voltage rail Gnd via the turned-on switching devices Q₃ and Q₄. Thus, the switching voltage V_{sw} is at substantially Gnd or 0V. Since, the output voltage Vₒ is greater than Gnd or 0V, the Buck converter 100 produces an inductor current i_{L} with a negative slope of substantially Vₒ/L.

In the discharging phase, the controller 110 configures the set of control signals G₁, G₂, G₃, G₄, G_{cbal_h} and G_{cbal_l} to be at logic low, high, low, high, high, and low states, respectively. Accordingly, in the discharging phase, the switching devices Q₂, Q₄, and Q_{cbal_h} are on, and the switching devices Q₁, Q₃, and Q_{cbal_l} are off. In this configuration, the fly capacitor C_{fly} and the balancing capacitor C_{bal} are coupled in parallel between the node at which the switching voltage Vsw is produced due to the turned on switching devices Q₂ and Q_{cbal_h}, and the lower voltage rail Gnd due to the turned-on switching device Q₄. The charge produced on the capacitors C_{fly} and C_{bal} during the charging phase discharge towards the inductor L (ergo, the discharging phase); thereby causing the switching voltage V_{sw} to be substantially at Vin/2 (or the same as V_{cfly} and V_{cbal}) Since, this is the case where Vₒ/Vᵢₙ is less than 0.5, V_{sw} is greater than Vₒ; thus, the Buck converter 100 produces an inductor current i_{L} with a positive slope of substantially (V_{cfly}−Vₒ)/L.

In the second holding phase, the controller 110 configures the set of control signals G₁, G₂, G₃, G₄, G_{cbal_h} and G_{cbal_l} to be the same as in the first holding phase; that is, to be at logic low, low, high, high, low, and low states, respectively. Accordingly, in the second holding phase, the switching devices Q₃ and Q₄ are on, and the switching devices Q₁, Q₂, Q_{cbal_h} and Q_{cbal_l} are off. In this configuration, the node at which the switching voltage V_{sw} is produced is coupled to the lower voltage rail Gnd via the turned-on switching devices Q₃ and Q₄. Thus, the switching voltage V_{sw} is at substantially Gnd or 0V. Since, the output voltage Vₒ is greater than Gnd or 0V, the Buck converter 100 produces an inductor current i_{L} with a negative slope of substantially Vₒ/L.

FIG. 2B illustrates a timing diagram of an exemplary switching mode operation of the Buck converter 100 for the case where the ratio of the output voltage Vₒ to the input voltage Vᵢₙ is greater than 0.5 (e.g., Vₒ/Vᵢₙ>0.5) in accordance with another aspect of the disclosure. In the Vₒ/Vᵢₙ>0.5 case, the switching voltage V_{sw} alternates between substantially Vᵢₙ and Vᵢₙ/2 in response to phases of the clock signal CLK. The horizontal axis of the timing diagram represents time, and the vertical axes represent different parameters, such as voltage in the case of V_{sw}, current in the case of i_{L}, and logic states in the case of the set of control signals G₁, G₂, G₃, G₄, G_{cbal_h} and G_{cbal_l}.

There are four (4) phases in a complete regulation cycle: (1) a charging phase whose details are depicted in the left-most column of the timing diagram; (2) a first holding phase whose details are depicted in the second column from the left; (3) a discharging phase whose details are depicted in the third column from the left; and (4) a second holding phase whose details are depicted in the right-most column. The duration of each phase may be related to (e.g., a half-period of) the clock signal CLK. The complete regulation cycle is repeated in order to control or regulate the output voltage Vₒ. Note that the second and fourth phases are the same (e.g., holding phases). Accordingly, there are three (3) distinct phases. Thus, the Buck converter 100 may be referred to as a three-phase or three-level Buck converter.

In the charging phase, the controller 110 configures the set of control signals G₁, G₂, G₃, G₄, G_{cbal_h} and G_{cbal_l} to be at logic high, low, high, low, low, and high states, respectively. Accordingly, in the charging phase, the switching devices Q₁, Q₃, and Q_{cbal_l} are on, and the switching devices Q₂, Q₄, and Q_{cbal_h} are off. In this configuration, the fly capacitor C_{fly} and the balancing capacitor C_{bal} are coupled in series between the upper voltage rail Vᵢₙ and the lower voltage rail Gnd to establish a current path to charge the capacitors (ergo, the charging phase). Since the capacitance of the fly and balancing capacitors C_{fly} and C_{bal} are substantially the same, the voltages V_{cfly} and V_{cbal} across the capacitors are also substantially the same at substantially Vᵢₙ/2. Also, in this configuration, the node between the capacitors C_{fly} and C_{bal} is coupled to the node at which the switching voltage V_{sw} is produced, via the turned-on switching device Q₃. Thus, the switching voltage V_{sw} is at substantially Vᵢₙ/2. Since, this is the case where Vₒ/Vᵢₙ is greater than 0.5, V_{sw} is less than Vₒ; thus, the Buck converter 100 produces an inductor current i_{L} with a negative slope of substantially Vₒ−(Vᵢₙ−V_{cfly})/L.

In the first holding phase, the controller 110 configures the set of control signals G₁, G₂, G₃, G₄, G_{cbal_h} and G_{cbal_l} to be at logic high, high, low, low, low, and low states, respectively. Accordingly, in the first holding phase, the switching devices Q₁ and Q₂ are on, and the switching devices Q₃, Q₄, Q_{cbal_h} and Q_{cbal_l} are off. In this configuration, the node at which the switching voltage V_{sw} is produced is coupled to the upper voltage rail Vᵢₙ via the turned-on switching devices Q₁ and Q₂. Thus, the switching voltage V_{sw} is at substantially Vᵢₙ. Since, the input voltage Vᵢₙ is greater than the output voltage Vₒ, the Buck converter 100 produces an inductor current i_{L} with a positive slope of substantially (Vin−Vₒ)/L.

In the discharging phase, the controller 110 configures the set of control signals G₁, G₂, G₃, G₄, G_{cbal_h} and G_{cbal_l} to be at logic low, high, low, high, high, and low states, respectively. Accordingly, in the discharging phase, the switching devices Q₂, Q₄, and Q_{cbal_h} are on, and the switching devices Q₁, Q₃, and Q_{cbal_l} are off. In this configuration, the fly capacitor C_{fly} and the balancing capacitor C_{bal} are coupled in parallel between the node at which the switching voltage V_{sw} is produced due to the turned on switching devices Q₂ and Q_{cbal_h}, and the lower voltage rail Gnd due to the turned-on switching device Q₄. The charge produced on the capacitors C_{fly} and C_{bal} during the charging phase discharge towards the inductor L (ergo, the discharging phase); thereby causing the switching voltage V_{sw} to be substantially at Vᵢₙ/2 (or the same as V_{cfly} and V_{cbal}). Since, this is the case where Vₒ/Vᵢₙ is greater than 0.5, V_{sw} is less than Vₒ; thus, the Buck converter 100 produces an inductor current i_{L} with a negative slope of substantially (Vₒ−V_{cfly})/L.

In the second holding phase, the controller 110 configures the set of control signals G₁, G₂, G₃, G₄, G_{cbal_h} and G_{cbal_l} the same as in the first holding phase; that is, to be at logic high, high, low, low, low, and low states, respectively. Accordingly, in the second holding phase, the switching devices Q₁ and Q₂ are on, and the switching devices Q₃, Q₄, Q_{cbal_h} and Q_{cbal_l} are off. In this configuration, the node at which the switching voltage V_{sw} is produced is coupled to the upper voltage rail Vᵢₙ via the turned-on switching devices Q₁ and Q₂. Thus, the switching voltage V_{sw} is at substantially Vᵢₙ. Since, the input voltage Vᵢₙ is greater than output voltage Vₒ, the Buck converter 100 produces an inductor current i_{L} with a positive slope of substantially (Vin−Vₒ)/L.

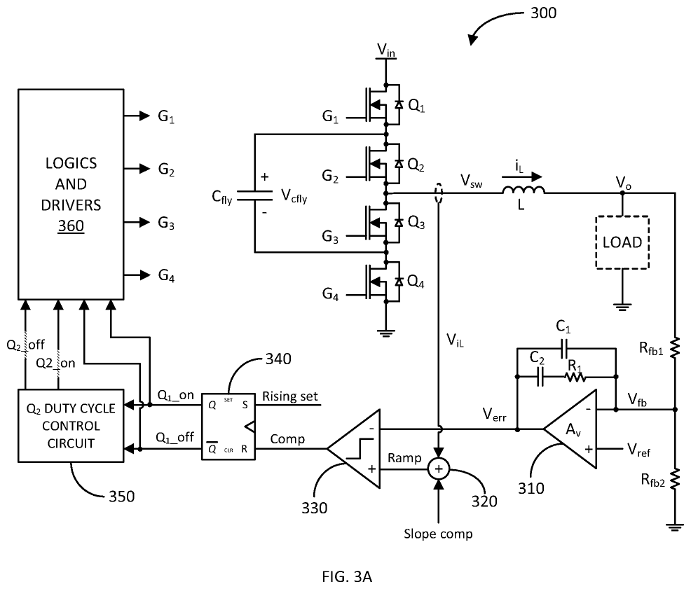

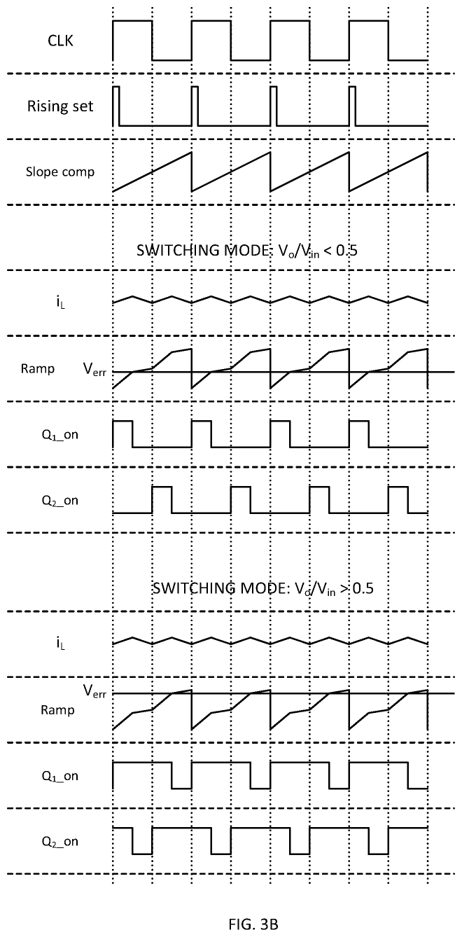

FIG. 3A illustrates a schematic diagram of another exemplary Buck converter 300 in accordance with another aspect of the disclosure. The Buck converter 300 may be configured similar to Buck converter 100, but includes a more detailed implementation of the controller 110, as discussed in more detail herein.

The Buck converter 300 includes the set of switching devices Q₁, Q₂, Q₃, and Q₄ coupled in series (in that order) between the upper voltage rail Vᵢₙ and the lower voltage rail Gnd. The set of switching devices Q₁, Q₂, Q₃, and Q₄ include control terminals (e.g., gates) configured to receive the set of control signals G₁, G₂, G₃, and G₄, respectively. Additionally, the Buck converter 300 includes a fly capacitor C_{fly} coupled between a first node between the first and second switching devices Q₁ and Q₂, and a second node between the third and fourth switching devices Q₃ and Q₄. The Buck converter 300 may include the voltage control circuit 105, but it is not shown in FIG. 3A as the description of the controller of Buck converter 300 deals mainly with controlling of the set of switching devices Q₁, Q₂, Q₃, and Q₄, and specifically, switching devices Q₁ and Q₂.

The Buck converter 300 is configured to generate a switching voltage V_{sw} at a node between switching devices Q₂ and Q₃. The Buck converter 300 further includes an inductor L coupled between the node between the switching devices Q₂ and Q₃ and a load. The load is coupled between the inductor L and the lower voltage rail Gnd. The output voltage Vₒ is generated across the load due to, at least in part, an inductor current i_{L} flowing through the inductor L and into the load.

The remaining components of the Buck converter 300 pertain to a controller, such as a more detailed implementation of controller 110, for controlling the set of switching devices Q₁, Q₂, Q₃, and Q₄ via the set of control signals G₁, G₂, G₃, and G₄, respectively.

In particular, the controller includes a voltage divider including first and second feedback resistors R_{fb1} and R_{fb2} coupled in series (in that order) across the load. The voltage divider generates a feedback voltage V_{fb} at a node between the feedback resistors R_{fb1} and R_{fb2}. The feedback voltage V_{fb} is related to the output voltage Vₒ by the voltage divider ratio (e.g., V_{fb}=Vₒ*R_{fb2}/(R_{fb1}+R_{fb2})).

The feedback voltage V_{fb} is applied to a negative input of an error amplifier 310. A reference voltage V_{ref} is applied to a positive input of the error amplifier 310. The reference voltage V_{ref} is related to a target output voltage V_{tgt} also by the voltage divider ratio (e.g., V_{ref}=V_{tgt}*R_{fb2}/(R_{fb1}+R_{fb2})). The error amplifier 310 is configured to generate an error voltage Vₑᵣᵣ related to a difference between the reference voltage V_{ref} and the feedback voltage V_{fb}. The error amplifier 310 includes a feedback network coupled between an output and negative input of the error amplifier. The feedback network includes a capacitor C₁ coupled in parallel with a series capacitor C₂ and resistor R₁ between the output and negative input of the error amplifier 310. The feedback sets the gain for the error amplifier 310 and performs filtering to generate a substantially DC error voltage Vₑᵣᵣ.

The controller further includes a voltage summer 320 configured to generate a “Ramp” voltage by summing a voltage Vi_{L} related to the inductor current i_{L} and a “slope compensation (comp)” signal. The controller further includes a comparator 330 including a negative input configured to receive the error voltage Vₑᵣᵣ from the error amplifier 310, and the Ramp voltage from the voltage summer 320. The comparator 330 is configured to generate a “Comp” signal based on a comparison of the error voltage Vₑᵣᵣ and the Ramp voltage.

The controller further includes a set-reset (SR) flip-flop 340 including a set input configured to receive a “Rising set” signal, a reset input configured to receive the Comp signal from the comparator 330, a Q output configured to output a Q₁_on control signal, and a Q̅ output configured to output a Q₁_off control signal. As discussed in more detail further herein, the Q₁_on and Q₁_off control signals are used to generate the control signals G₁ and G₄ for controlling the on-duty cycles of switching devices Q₁ and Q₄, respectively.

The controller further includes a Q₂ duty cycle control circuit 350 configured to generate Q₂_on and Q₂_off control signals based on the Q₁_on and Q₁_off control signals, respectively. As discussed in more detail further herein, the Q₂_on and Q₂_off control signals are used to generate the control signals G₃ and G₄ for controlling the on-duty cycles of switching devices Q₃ and Q₄, respectively. The controller includes logics and drivers 360 for processing (e.g., level shifting, etc.) the Q₁_on, Q₁_off, Q₂_on, and Q₂_off control signals to generate the control signals G₁, G₄, G₃, and G₄, respectively. The control and regulation of the output voltage Vₒ is discussed in more detail below with reference to FIG. 3B.

FIG. 3B illustrates a timing diagram of an exemplary operation of the Buck converter 300 in accordance with another aspect of the disclosure. The horizontal axis of the timing diagram represents time, and the vertical axis represents various parameters. From top to bottom, the parameters include: the clock signal (CLK), the Rising set signal, and the slope comp signal; the inductor current i_{L}, the Ramp signal, the Q₁_on signal, and the Q₂_on signal for the case where Vₒ/Vᵢₙ<0.5; and the inductor current i_{L}, the Ramp signal, the Q₁_on signal, and the Q₂_on signal for the case where Vₒ/Vᵢₙ>0.5.

The clock signal controls the various timing operations of the controller. The Rising set signal includes a reset pulse coinciding with the rising edge of the clock signal. The slope comp is a ramp or sawtooth voltage that begins increasing from a starting voltage at the rising edge of the clock, and returns back to the starting voltage at the next rising edge of the clock signal to begin the next rising cycle.

With reference to the switching mode where Vₒ/Vᵢₙ<0.5, at the beginning of a complete regulation cycle, the Rising set causes the SR-flip-flop 340 to generate the control signal Q₁_on as a logic high voltage and the control signal Q₁_off as a logic low voltage. The control signals Q₁_on and control signals Q₁_off being at logic high and low voltages, respectively, cause the logics and drivers 360 to turn on switching device Q₁ and turn off switching device Q₄, respectively. The Q₂ duty cycle control circuit 350 basically copies the control signals Q₁_on and Q₁_off, and phase shifts them by substantially 180 degrees, to generate the control signals Q₂_on and Q₂_off. Accordingly, the control signals Q₂_on and Q₂_off are at logic low and high voltages when the pulse of the Rising set signal occurs. The control signals Q₂_on and control signals Q₂_off being at logic low and high voltages, respectively, cause the logics and drivers 360 to turn off switching device Q₂ and turn on switching device Q₃, respectively. With reference to FIG. 2A, this initiates the charging phase of the complete regulation cycle.

The voltage summer 320 generates the Ramp voltage by summing the inductor current related voltage V_{iL} and the slope comp voltage. Thus, at the time of the pulse of the Rising set, the Ramp voltage increases with a relatively high slope during the charging phase (because the inductor current i_{L} is increasing), increases with a relatively low slope during the first holding phase (because the inductor current i_{L} is decreasing), increases again with the relatively high slope during the discharging phase (because the inductor current i_{L} is increasing), and then increases with the relatively low slope during the second holding phase (because the inductor current i_{L} is decreasing). The full rise of the Ramp voltage represents the full range of the output voltage Vₒ from Gnd (0V) to Vᵢₙ. The error voltage Vₑᵣᵣ, indicated as a horizontal line, corresponds to the target output voltage V_{tgt}. As this is the case where Vₒ/Vᵢₙ<0.5, the error voltage Vₑᵣᵣ line is less than halfway of the full rise of the Ramp voltage.

In response to the Ramp voltage reaching the error voltage Vₑᵣᵣ, the comparator 330 changes the Comp voltage from a logic low voltage to a logic high voltage. This causes the SR-flip-flop 340 to reset; thereby, generating the Q₁_on control signal as a logic low voltage, and the Q₁_off signal as a logic high voltage. In response to the Q₁_on and Q₁_off control signals being at logic low and high voltages, respectively, the logics and drivers 360 turns off switching device Q₁ and turns on switching device Q₄, respectively. With reference to FIG. 2A, this signals the start of the first holding phase. Note that the switching device Q₁ is turned off for the remaining phases of the complete regulation cycle. Thus, the on-duty cycle of the switching device Q₁ is controlled by the peak current through switching device Q₁.

As discussed, the Q₂ duty cycle control circuit 350 basically copies the control signals Q₁_on and Q₁_off, and phase shifts them by substantially 180 degrees, to generate the control signals Q₂_on and Q₂_off. When 180-phase shift has occurred from the pulse of the Rising set, the Q₂ duty cycle control circuit 350 generates the control signals Q₂_on and Q₂_off at logic high and low voltages, respectively. In response to the control signals Q₂_on and Q₂_off being logic high and low voltages, respectively, the logics and drivers 360 turns on switching device Q₂ and turns off switching device Q₃, respectively. With reference to FIG. 2A, this signals the start of the discharging phase.

When an additional 90-degree phase occurs, the Q₂ duty cycle control circuit 350 generates the control signals Q₂_on and Q₂_off at logic low and high voltages, respectively. In response to the control signals Q₂_on and Q₂_off at logic low and high voltages, the logics and drivers 360 turns off switching device Q₂ and turns on switching device Q₃, respectively. With reference to FIG. 2A, this signals the start of the second holding phase. The second holding phase continues until the next pulse of the Rising set signal, which initiates the next complete regulation cycle.

With reference to the switching mode where Vₒ/Vᵢₙ>0.5, at the beginning of a complete regulation cycle, the Rising set causes the SR-flip-flop 340 to generate the control signal Q₁_on as a logic high voltage and the control signal Q₁_off as a logic low voltage. The control signals Q₁_on and control signals Q₁_off being at logic high and low voltages, respectively, cause the logics and drivers 360 to turn on switching device Q₁ and turn off switching device Q₄, respectively. The Q₂ duty cycle control circuit 350 basically copies the control signals Q₁_on and Q₁_off, and phase shifts them by substantially 180 degrees, to generate the control signals Q₂_on and Q₂_off. Accordingly, the control signals Q₂_on and Q₂_off are at logic high and low voltages when the pulse of the Rising set signal occurs. The control signals Q₂_on and control signals Q₂_off being at logic high and low voltages, respectively, cause the logics and drivers 360 to turn on switching device Q₂ and turn off switching device Q₃, respectively. With reference to FIG. 2B, this initiates the second holding phase of the complete regulation cycle.

The voltage summer 320 generates the Ramp voltage by summing the inductor current related voltage V_{iL} and the slope comp voltage. Thus, at the time of the pulse of the Rising set, the Ramp voltage increases with a relatively high slope during the second holding phase (because the inductor current i_{L} is increasing), increases with a relatively low slope during the charging phase (because the inductor current i_{L} is decreasing), increases again with the relatively high slope during the first holding phase (because the inductor current i_{L} is increasing), and then increases with the relatively low slope during the discharging phase (because the inductor current i_{L} is decreasing). As discussed, the full rise of the Ramp voltage represents the full range of the output voltage Vₒ from Gnd (0V) to Vᵢₙ. The error voltage Vₑᵣᵣ, indicated as a horizontal line, corresponds to the target output voltage V_{tgt}. As this is the case where Vₒ/Vᵢₙ>0.5, the error voltage Vₑᵣᵣ line is greater than halfway of the full rise of the Ramp voltage.

As discussed, the Q₂ duty cycle control circuit 350 basically copies the control signals Q₁_on and Q₁_off, and phase shifts them by substantially 180 degrees, to generate the control signals Q₂_on and Q₂_off. When 90-degree phase shift has occurred from the pulse of the Rising set, the Q₂ duty cycle control circuit 350 generates the control signals Q₂_on and Q₂_off at logic low and high voltages. In response to the control signals Q₂_on and Q₂_off being at logic low and high voltages, the logics and drivers 360 turns off switching device Q₂ and turns on switching device Q₃, respectively. With reference to FIG. 2B, this signals the start of the charging phase.

When another 90-degree phase shift has occurred, the Q₂ duty cycle control circuit 350 generates the control signals Q₂_on and Q₂_off at logic high and low voltages. In response to the control signals Q₂_on and Q₂_off being at logic high and low voltages, the logics and drivers 360 turns on switching device Q₂ and turns off switching device Q₃, respectively. With reference to FIG. 2B, this signals the start of the first holding phase.

In response to the Ramp voltage reaching the error voltage Vₑᵣᵣ, the comparator 330 changes the Comp voltage from a logic low voltage to a logic high voltage. This causes the SR-flip-flop 340 to reset; thereby, generating the Q₁_on control signal as a logic low voltage, and the Q₁_off signal as a logic high voltage. In response to the Q₁_on Q₁_off control signals being at logic low and high voltages, respectively, the logics and drivers 360 turns off switching device Q₁ and turns on switching device Q₄, respectively. With reference to FIG. 2B, this signals the start of the discharging phase. Note that the switching device Q₁ is turned off for the remaining phase of the complete regulation cycle. Thus, the on-duty cycle of the switching device Q₁ is controlled by the peak current through switching device Q₁.

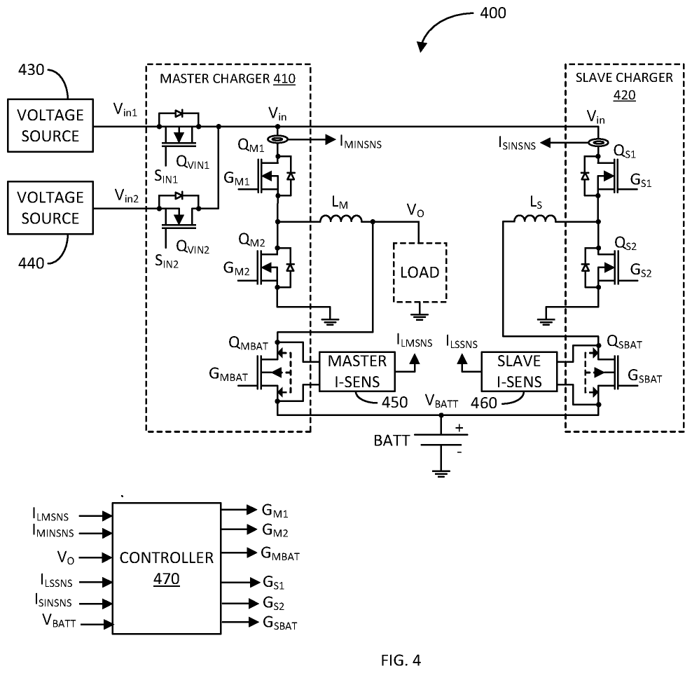

FIG. 4 illustrates a schematic diagram of an exemplary two-level Buck converter 400 including a master charger 410 and a slave charger 420 for a battery “BATT” and a load in accordance with another aspect of the disclosure. Each of the master charger 410 and slave charger 420 is configured as a two-level Buck converter (e.g., each having two switching devices for generating a charging current for the battery).

The master charger 410 includes a high-side master switching device Q_{M1} and a low-side master switching device Q_{M2} coupled between an upper voltage rail Vᵢₙ and a lower voltage rail (e.g., Gnd). The master charger 410 further includes a master inductor L_{M} coupled between a node between the high- and low-side master switching devices Q_{M1} and Q_{M2}, and a master battery transistor Q_{MBAT} The master battery transistor Q_{MBAT}, in turn, is coupled between the master inductor L_{M} and the battery. A load is coupled between the master inductor L_{M} and the lower voltage rail (e.g., Gnd).

Similarly, the slave charger 420 includes a high-side slave switching device Q_{S1} and a low-side slave switching device Q_{S2} coupled between the upper voltage rail Vᵢₙ and the lower voltage rail (e.g., Gnd). The slave charger 420 further includes a slave inductor L_{S} coupled between a node between the high- and low-side slave switching devices Q_{S1} and Q_{S2}, and a slave battery transistor Q_{SBAT}. The slave battery transistor Q_{SBAT}, in turn, is coupled between the slave inductor L_{S} and the battery.

In this example, the Buck converter 400 includes two voltage sources 430 and 440 of input voltages Vᵢₙ₁ and Vᵢₙ₂ to be selectively applied to the upper voltage rail Vᵢₙ, respectively. For example, the input voltage source 430 may be a Universal Serial Bus (USB) voltage source configured to generate an input voltage Vᵢₙ₁, and the input voltage source 440 may be a tri-mode wireless charging receiver including a Stark analog-front-end (AFE) reverse-blocking component configured to generate another input voltage Vᵢₙ₂. The master charger 410 includes two switching devices Q_{VIN1} and Q_{VIN2} for selectively applying the input voltage Vᵢₙ₁ or Vᵢₙ₂ from either the USB source 430 or the wireless charging source 440, respectively.

The slave charger 420 is usually operated during constant current mode when a relatively high current is required to be supplied to the battery. The master battery transistor Q_{MBAT} includes an associated master current sensor 450 to sense the current supplied to the battery by the master charger 410. The sensed current I_{LMSNS}, in conjunction with the master input current I_{MINSNS} and the output voltage V_{O}, are used to control the switching operation of the high-side and low-side master switching devices Q_{M1} and Q_{M2} in different operating modes via the gate drive signals G_{M1} and G_{M2} generated by a controller 470. The controller 470 may also control the on and off state of the master battery transistor Q_{MBAT} via the G_{MBAT} control signal.

The slave battery transistor Q_{SBAT} includes an associated slave current sensor 460 to sense the current supplied to the battery by the slave charger 420. The sensed current I_{LSSNS}, in conjunction with the slave input current I_{SINSNS} and the battery voltage V_{BATT}, are used to control the switching operation of the high-side and low-side slave switching devices Q_{S1} and Q_{S2} via the gate drive signals G_{S1} and G_{S2} generated by the controller 470, to improve efficiency by balancing the currents supplied to the battery by the master and slave chargers 410 and 420. The controller 470 may also control the on and off state of the slave battery transistor Q_{SBAT} via the G_{SBAT} control signal.

There are various drawbacks with the slave battery transistor Q_{SBAT} and associated control circuitry of the slave charger 420. For example, the slave battery transistor Q_{SBAT} and associated control circuitry generally requires a relatively large circuit or integrated circuit (IC) area to implement. As the current supplied to the battery flows through the slave battery transistor Q_{SBAT}, there is loss in power efficiency due to IR losses across the on-resistance of the slave battery transistor Q_{SBAT}. Additionally, an IC incorporating the slave charger 420 includes several pins/pads for the slave battery transistor Q_{SBAT} and its control circuitry. Moreover, the slave battery transistor Q_{SBAT} is not configured well for overcurrent protection as it senses the average current supplied to the battery, and not the peak current, which is more relevant in overcurrent protection.

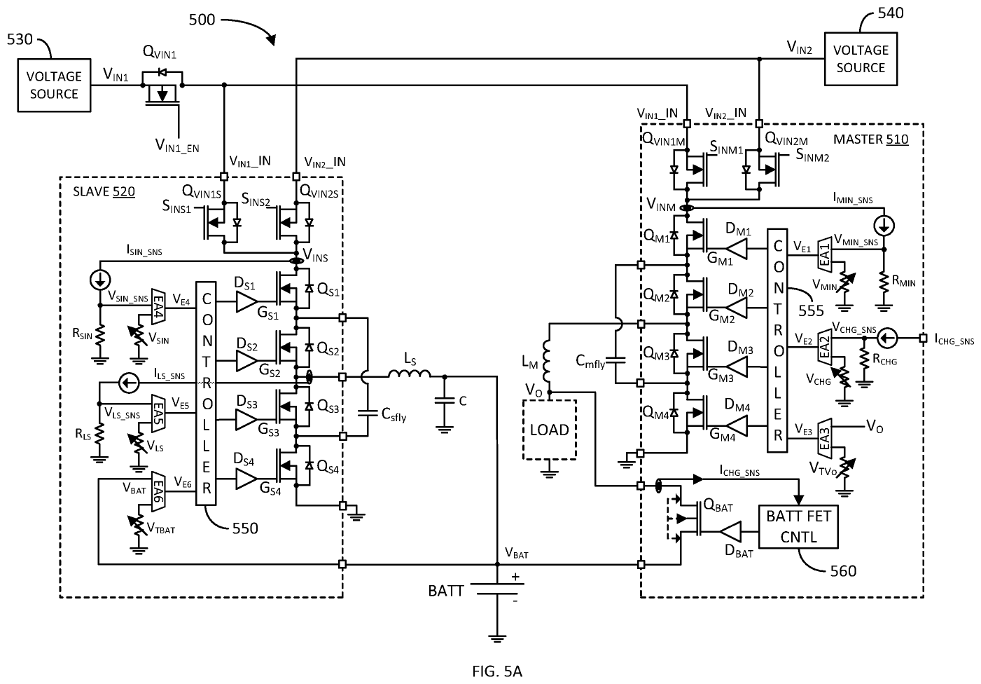

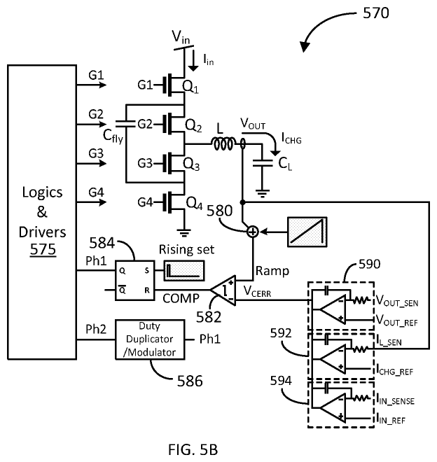

FIG. 5A illustrates a schematic diagram of another exemplary three-level Buck converter 500 including master and slave chargers for a battery (or load) in accordance with another aspect of the disclosure. The Buck converter 500 includes a master charger 510 and a slave charger 520. Each of the master and slave chargers 510 and 520 are configured as three-level Buck converters, and each include four (4) series switching devices with associated control circuitry.

The design philosophy of the slave charger 520 is to manage the slave charging current without using the slave battery transistor Q_{SBAT} and its control circuitry. Instead, to manage the charging current of the slave charger 520, the inductor current is sensed, and the charging control loop is controlled by the sensed inductor current. Accordingly, power efficiency may be improved by avoiding the turn-on resistance of the slave battery transistor Q_{SBAT}. In addition, since the inductor current has peak current information, better overcurrent protection may be provided by an overcurrent protection circuit. Furthermore, the removal of the slave battery transistor Q_{SBAT} and its control circuitry results in significant circuit or IC area savings.

More specifically, the three-level Buck converter 500 includes a master charger 510 and a slave charger 520. The master charger 510 includes four (4) switching devices Q_{M1} to Q_{M4} (e.g., FETs) coupled in series between an upper voltage rail V_{INM} and a lower voltage rail (e.g., Gnd). The master charger 510 further includes a controller 555 configured to generate gate drive signals G_{M1} to G_{M4} via drivers (e.g., charge pumps) D_{M1} to D_{M4} for the switching devices Q_{M1} to Q_{M4}, respectively. The master charger 510 includes a fly capacitor C_{mfly} coupled between a node between switching devices Q_{M1} and Q_{M2}, and a node between Q_{M3} and Q_{M4}. The master charger 510 further includes an inductor L_{M} coupled between a node between switching devices Q_{M2} and Q_{M3}, and a drain terminal of a battery FET Q_{BAT} The battery FET Q_{BAT} includes a source terminal coupled to a positive terminal of the battery, wherein the battery negative terminal is coupled to the lower voltage rail (e.g., Gnd). A load is coupled between the inductor L_{M} (drain of the battery FET Q_{BAT}) and the lower voltage rail (e.g., Gnd).

The master charger 510 further includes a first error amplifier (EA1) configured to generate a first error voltage V_{E1} based on a difference between a voltage V_{MIN_SNS} representative of the sensed master input current I_{MIN_SNS} into the switching device Q_{M1}, and a voltage V_{MIN} representative of a target input current limit (which may be variably set). The voltage V_{MIN_SNS} may be generated by the current I_{MIN_SNS} flowing through resistor R_{MIN}. The voltage V_{MIN} may be generated by a current (not shown) flowing through a variable resistor. The controller 555 controls the switching devices Q_{M1} to Q_{M4} based on the first error voltage V_{E1} to regulate the sensed master input current I_{MIN_SNS} to be substantially the same as the target input current limit T_{MIN}.

The master charger 510 further includes a second error amplifier (EA2) configured to generate a second error voltage V_{E2} based on a difference between a voltage V_{CHG_SNS} representative of the sensed battery charge current I_{CHG_SNS}, and a voltage V_{CHG} representative of a target battery charge current V_{CHG} (which may be variably set). The voltage V_{CHG_SNS} may be generated by the current I_{CHG_SNS} flowing through resistor R_{CHG}. The voltage V_{CHG} may be generated by a current (not shown) flowing through a variable resistor. The controller 555 controls the switching devices Q_{M1} to Q_{M4} based on the second error voltage V_{E2} to regulate the sensed battery charge current I_{CHG_SNS} to be substantially the same as the target battery charge current as indicated by V_{CHG}.

The master charger 510 further includes a third error amplifier (EA2) configured to generate a third error voltage V_{E3} based on a difference between the output voltage V_{O} representative of the voltage across the load, and a voltage V_{TVo} representative of a target output voltage V_{TVo} (which may be variably set). The voltage V_{TVo} may be generated by a current (not shown) flowing through a variable resistor. The controller 555 controls the switching devices Q_{M1} to Q_{M4} based on the third error voltage V_{E3} to regulate the output voltage Vo to be substantially the same as the target output voltage V_{TVo}.

The master charger 510 further includes a battery FET controller 560 configured to control the on-resistance of the battery FET Q_{BAT} based on the sensed battery charge current I_{CHG_SNS} via the FET driver (e.g., charge pump) D_{BAT}. The battery FET controller 560 controls the charging current for the battery and provides over-current protection in order to protect the battery from excessive current.

The slave charger 520 includes four (4) switching devices Q_{S1} to Q_{S4} (e.g., FETs) coupled in series between an upper voltage rail V_{IN}s and the lower voltage rail (e.g., Gnd). The slave charger 520 further includes a controller 550 configured to generate gate drive signals G_{S1} to G_{S4} via drivers (e.g., charge pumps) D_{S1} to D_{S4} for the switching devices Q_{S1} to Q_{S4}, respectively. The slave charger 520 includes a fly capacitor C_{sfly} coupled between a node between switching devices Q_{S1} and Q_{S2}, and a node between Q_{S3} and Q_{S4}. The slave charger 520 further includes an inductor L_{S} coupled between a node between switching devices Q_{S2} and Q_{S3}, and a positive terminal of the battery. A noise/ripple filtering capacitor C may be coupled between the inductor L_{S} and the lower voltage rail (e.g., Gnd).

The slave charger 520 further includes a fourth error amplifier (EA4) configured to generate a fourth error voltage V_{E4} based on a difference between a voltage V_{SIN_SNS} representative of the sensed slave input current I_{SIN_SNS} into the switching device Q_{S1}, and a voltage V_{SIN} representative of a target input current limit (which may be variably set). The voltage V_{SIN_SNS} may be generated by the current I_{SIN_SNS} flowing through resistor R_{SIN}. The voltage V_{SIN} may be generated by a current (not shown) flowing through a variable resistor. The controller 550 controls the switching devices Q_{S1} to Q_{S4} based on the fourth error voltage V_{E4} to regulate the sensed slave input current I_{SIN_SNS} to be substantially the same as the target input current limit V_{SIN}.

The slave charger 520 further includes a fifth error amplifier (EA5) configured to generate a fifth error voltage V_{E5} based on a difference between a voltage V_{LS_SNS} representative of the sensed slave inductor current I_{LS_SNS}, and a voltage V_{LS} representative of a target slave inductor current (which may be variably set). The voltage V_{LS_SNS} may be generated by the current I_{LS_SNS} flowing through resistor R_{LS}. The voltage V_{LS} may be generated by a current (not shown) flowing through a variable resistor. The controller 550 controls the switching devices Q_{S1} to Q_{S4} based on the fourth error voltage V_{E4} to regulate the sensed inductor current I_{LS_SNS} to be substantially the same as the target inductor current as indicated by V_{LS}.

The slave charger 520 further includes a sixth error amplifier (EA6) configured to generate a sixth error voltage V_{E6} based on a difference between the battery voltage V_{BAT} representative of the voltage at the positive terminal of the battery, and a voltage V_{TBAT} representative of a target battery voltage V_{TBAT} (which may be variably set). The voltage V_{TBAT} may be generated by a current (not shown) flowing through a variable resistor. The controller 550 controls the switching devices Q_{S1} to Q_{S4} based on the sixth error voltage V_{E6} to regulate the battery voltage V_{BAT} to be substantially the same as the target battery voltage V_{BAT}.

The three-level Buck converter 500 may receive supply voltages from a plurality of voltage sources, such as voltage source 530 and voltage source 540. As an example, the voltage source 530 may be a Universal Serial Bus (USB) voltage source, and the voltage source 540 may be a wireless charger. In this example, the voltage source 530 generates a supply voltage V_{IN1}, and the voltage source 540 may generate a supply voltage V_{IN2}. The three-level Buck converter 500 further includes an enable switching device (e.g., FET) Q_{VIN1} for selectively applying the supply voltage V_{IN1} from the voltage source 530 to the inputs V_{IN1_IN} of the master charger 510 and the slave charger 520 via a control signal V_{IN1_EN} The supply voltage V_{IN2} from the voltage source 540 may be applied directly to the inputs V_{IN2_IN} of the master charger 510 and slave charger 520.

The master charger 510 includes a pair of input voltage select switching devices (e.g., FETs) Q_{VIN1M} and Q_{VIN2M}. The switching device Q_{VIN1M} is coupled between the enable switching device Q_{VIN1} and the first switching device Q_{M1} of the master charger 510. A control signal S_{INM1} is applied to the gate of the switching device Q_{VIN1M}. Similarly, the switching device Q_{VIN2M} is coupled between the voltage source 540 and the first switching device Q_{M1} of the master charger 510. A control signal S_{INM2} is applied to the gate of the switching device Q_{VIN2M}. The control signals S_{INM1} and S_{INM2} selects which supply voltage V_{IN1} or V_{IN2} to provide to the switching devices Q_{M1} to Q_{M4} of the master charger 510 by turning on and off the selected and unselected switching devices Q_{VIN1M} and Q_{VIN2M}, respectively.

Similarly, the slave charger 520 includes a pair of input voltage select switching devices (e.g., FETs) Q_{VIN1S} and Q_{VIN2S}. The switching device Q_{VIN1S} is coupled between the enable switching device Q_{VIN1} and the first switching device Q_{S1} of the slave charger 520. A control signal S_{INS1} is applied to the gate of the switching device Q_{VIN1S}. Similarly, the switching device Q_{VIN2S} is coupled between the voltage source 540 and the first switching device Q_{S1} of the slave charger 520. A control signal S_{INS2} is applied to the gate of the switching device Q_{VIN2S}. The control signals S_{INS1} and S_{INS2} selects which supply voltage V_{IN1} or V_{IN2} to provide to the switching devices Q_{S1} to Q_{S4} of the slave charger 520 by turning on and off the selected and unselected switching devices Q_{VIN1S} and Q_{VIN2S}, respectively.

As illustrated, the slave charger 520 does not include a battery FET. Advantages that follow from not including a slave battery FET includes no voltage drop across the slave battery FET, which saves power; the sensed inductor current via the slave battery FET is the average current through the inductor L_{S}, which may not be that useful for over-current protection where peak current may be more relevant for over-current protection; and the slave battery FET and associated control circuit typically occupies substantial amount of circuit or integrated circuit (IC) footprint.

FIG. 5B illustrates a schematic diagram of another exemplary three-level Buck converter 570 including a slave charger control circuit for a battery (or load) in accordance with another aspect of the disclosure. The three-level Buck converter 570 is similar to the Buck converter 300, and includes many similar elements. As discussed, the slave charger control circuit uses a sensed inductor current I_{L}_SEN for controlling the operations of the switching devices via the other components of the controller. Accordingly, the slave charger control circuit does not use the slave battery transistor Q_{SBAT} and its control circuitry for controlling the operating of the switching devices because of the drawback previously discussed.

More specifically, the three-level Buck converter 570 includes a set of switching devices (e.g., FETs) Q₁ to Q₄ coupled in series between an upper voltage rail Vᵢₙ and a lower voltage rail (e.g., Gnd). The Buck converter 570 further includes a fly capacitor C_{fly} coupled between a first node between Q₁ and Q₂, and a second node between Q₃ and Q₄. The Buck converter 570 further includes an inductor L coupled in series with a capacitive load C_{L} (e.g., battery) coupled between a third node between Q₂ and Q₃ and the lower voltage rail (e.g., Gnd).

With regard to controlling the switching devices Q₁ to Q₄, the Buck converter 570 includes a summer 580 configured to generate a Ramp voltage by summing a voltage based on a current through the inductor L and a slope comp voltage. The Buck converter 570 further includes a set of error amplifiers 590, 592, and 596 for generating a cumulative error voltage V_{CERR}. The error amplifier 590 is configured to generate a first error voltage component of the cumulative error voltage V_{CERR} based on a difference between the sensed output voltage V_{OUT_SEN} and a reference (target) output voltage V_{OUT_REF}. The error amplifier 592 is configured to generate a second error voltage component of the cumulative error voltage V_{CERR} based on a difference between the sensed inductor current I_{L_SEN} and a reference (target) charge current I_{CHG_REF}. The error amplifier 594 is configured to generate a third error voltage component of the cumulative error voltage V_{CERR} based on a difference between the sensed input current I_{IN_SENSE} and a reference (target) input current I_{IN_REF}.

The Buck converter 570 includes a comparator 582 including a positive input configured to receive the Ramp voltage and a negative input configured to receive cumulative error voltage V_{CERR}. The Buck converter 570 further includes a set-reset (SR) flip-flop 584 including a set input configured to receive a regulation cycle initiating pulse, and reset input configured to receive a compensation (COMP) signal of the comparator 582, and a Q-output configured to generate a Ph1 signal, which is provided to a logics and drivers component 575. The Buck converter 570 further includes a duty-cycle duplicator/modulator 586 configured to generate a Ph2 signal by phase shifting the Ph1 signal by 180 degrees. The Ph2 signal is provided to the logics and drivers component 575.

The logics and drivers component 575 generate the gate drive signals G₁ to G₄ for the switching devices Q₁ to Q₄, respectively. The Ph1 signal controls the on/off state of switching devices Q₁ and Q₄. The Ph2 signal controls the on/off state of switching devices Q₂ and Q₃.

In the duty cycle (V_{ow}/Vᵢₙ)>0.5 mode, the Rising set initiating pulse causes the SR flip-flop 584 to generate the Ph1 signal as a logic high, and the duty-cycle duplicator/modulator 586 responsively generates the Ph2 signal as a logic low. The Ph1 signal, being a logic high, causes the logics and drivers component 575 to turn on Q₁ and turn off Q₂. The Ph2 signal, being a logic low, causes the logics and drivers component 575 to turn off Q₂ and turn on Q₃. This initiates the charging (of the fly capacitor C_{fly}) phase. The charging phase ends when the Ramp voltage reaches the cumulative voltage V_{CERR}.

When the Ramp voltage reaches the cumulative voltage V_{CERR}, the comparator 582 generates the COMP signal as a logic high to cause the SR flip-flop 584 to reset, and output the Ph1 signal as a logic low. The Ph1 signal, being a logic low, causes the logics and drivers component 575 to turn off Q₁ and turn on Q₄. As only 90 degrees has commenced since the Rising set initiating pulse, the duty-cycle duplicator/modulator 586 maintains the Ph2 signal at a logic low, causing the logics and drivers component 575 to maintain Q₂ off and Q₃ on. This initiates the first holding phase.

When 180 degrees has commenced since the initiating pulse, the duty-cycle duplicator/modulator 586 sets the Ph2 signal to a logic high, causing the logics and drivers component 575 to turn on Q₂ and turn off Q₃. This initiates the discharging (of the fly capacitor C_{fly}) phase. Then, when 270 degrees has commenced since the initiating pulse, the duty-cycle duplicator/modulator 586 sets the Ph2 signal to a logic low, causing the logics and drivers component 575 to turn off Q₂ and turn on Q₃. This initiates the second holding phase, which is the last phase of the regulation cycle.

Since the cumulative voltage V_{CERR} is made up of a summation of the error voltages with respect to the sensed output voltage I_{OUT_SEN} versus a target output voltage V_{OUT_REF}, the sensed inductor current I_{L_SEN} versus a target charging current I_{CHG_REF}, and the sensed input current I_{IN_SENSE} versus a target input current I_{IN_REF}, and the cumulative voltage V_{CERR} determines the duration of the charging phase, through negative feedback, the control system of the Buck converter 570 ensures that the output voltage V_{OUT}, the inductor current I_{L}, and the input current I_{IN} are substantially the same as the target output voltage V_{OUT_REF}, target charging current I_{CHG_REF}, and the target input current I_{IN_REF}, respectively.

In the duty cycle (Vₒᵤₜ/Vᵢₙ)>0.5 mode, the Rising set initiating pulse causes the SR flip-flop 584 to generate the Ph1 signal as a logic high, and the duty-cycle duplicator/modulator 586 responsively generate the Ph2 signal as a logic high. The Ph1 signal, being a logic high, causes the logics and drivers component 575 to turn on Q₁ and turn off Q₄. The Ph2 signal, being a logic high, causes the logics and drivers component 575 to turn on Q₂ and turn off Q₃. This initiates the first holding phase.

When 90 degrees has commenced since the initiating pulse, the duty-cycle duplicator/modulator 586 sets the Ph2 signal to a logic low, causing the logics and drivers component 575 to turn off Q₂ and turn on Q₃. This initiates the charging (of the fly capacitor C_{fly}) phase. Then, when 180 degrees has commenced since the initiating pulse, the duty-cycle duplicator/modulator 586 sets the Ph2 signal to a logic high, causing the logics and drivers component 575 to turn on Q₂ and turn off Q₃. This initiates the second holding phase.

When the Ramp voltage reaches the cumulative voltage V_{CERR}, the comparator 582 generates the COMP signal as a logic high to cause the SR flip-flop 584 to reset, and output the Ph1 signal as a logic low. The Ph1 signal, being a logic low, causes the logics and drivers component 575 to turn off Q₁ and turn on Q₄. At 270 degrees since the Rising set initiating pulse, the duty-cycle duplicator/modulator 586 maintains the Ph2 signal at a logic high, causing the logics and drivers component 575 to maintain Q₂ on and Q₃ off. This initiates the discharging (of the fly capacitor C_{fly}) phase. This is the last phase of the regulation cycle.

Again, since the cumulative voltage V_{CERR} is made up of a summation of the error voltages with respect to the sensed output voltage V_{OUT_SEN} versus a target output voltage V_{OUT_REF}, the sensed inductor current I_{L_SEN} versus a target charging current I_{CHG_REF}, and the sensed input current I_{IN_SENSE} versus a target input current I_{IN_REF}, and the cumulative voltage V_{CERR} determines the duration of the second holding phase, through negative feedback, the control system of the Buck converter 570 ensures that the output voltage V_{OUT}, the inductor current I_{L}, and the input current I_{IN} are substantially the same as the target output voltage V_{OUT_REF}, target charging current I_{CHG_REF}, and the target input current I_{IN_REF}, respectively.

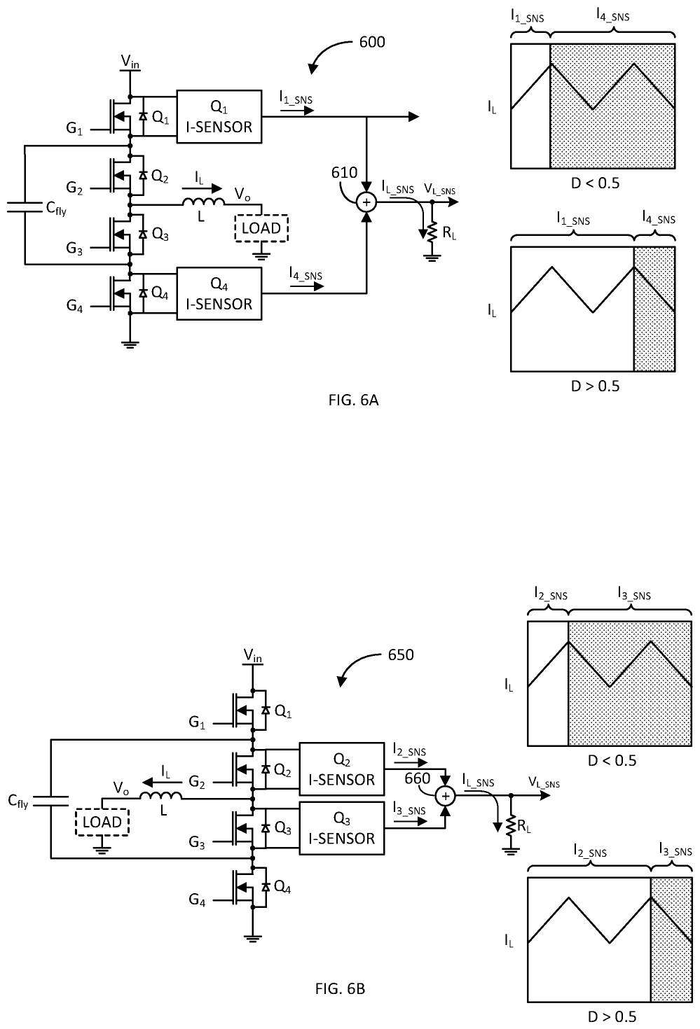

FIG. 6A illustrates a schematic diagram of another exemplary three-level Buck converter 600 with high-side and low-side switching devices current sensors Q_{1SEN} and Q_{4SEN} in accordance with another aspect of the disclosure. The high-side current sensor Q_{1SEN} is coupled across the first switching device Q₁, and is configured to generate a first sensed current I_{1_SNS} related to the current through the first switching device Q₁. The low-side current sensor Q_{4SEN} is coupled across the fourth switching device Q₄, and is configured to generate a second sensed current I_{4_SNS} related to the current through the fourth switching device Q₄.

The first and second sensed currents I_{1_SNS} and I_{4_SNS} are summed by a current summer 610 to generate a sensed inductor current I_{L_SNS} (e.g., related to or substantially the same as the inductor current) to generate a control signal or voltage V_{L_SNS} for a master/slave charger across a resistor R_{L}.

The upper-right and lower-right graphs of FIG. 6A illustrate how the inductor current is sensed via the first and second sensed current I_{1_SNS} and I_{4_SNS}. The upper-right graph pertains to the case where the ratio (D) of the output voltage Vₒ to the input voltage is less than 0.5. The lower-right graph pertains to the case where the ratio (D) of the output voltage Vₒ to the input voltage is greater than 0.5. The horizontal axis represents time.

The upper-graph explains that the first sensed current I_{1_SNS} is substantially the same as the left portion of the inductor current I_{L}, and the second sensed current I_{4_SNS} is substantially the same as the right (highlighted) portion of the inductor current I_{L}. Thus, summing the first and second sensed currents I_{1_SNS} and I_{4_SNS} by the summer 610 generates the entire sensed inductor current I_{L_SNS}. Similarly, the lower-graph explains that the first sensed current I_{1_SNS} is substantially the same as the left portion of the inductor current I_{L}, and the second sensed current I_{4_SNS} is substantially the same as the right (highlighted) portion of the inductor current I_{L}. Thus, summing the first and second sensed currents I_{1_SNS} and I_{4_SNS} by the summer 610 generates the entire sensed inductor current.

Although, in this example, the current sensors are applied across the first and fourth switching devices Q₁ and Q₄, it shall be understood that the current sensors may be applied across the switching devices Q₂ and Q₃, respectively. In the latter case, the current sensors generate first and second sensed currents, which when summed, substantially equals the sensed inductor current for Buck converter control purposes. For the sake of completeness, this is discussed below with reference to FIG. 6B.

FIG. 6B illustrates a schematic diagram of another exemplary three-level Buck converter 650 with upper-middle-side and lower-middle-side switching devices current sensors Q_{2SEN} and Q_{3SEN} in accordance with another aspect of the disclosure. The upper-middle-side current sensor Q_{2SEN} is coupled across the second switching device Q₂, and is configured to generate a first sensed current I_{2_SNS} related to the current through the second switching device Q₂. The lower-middle-side current sensor Q_{3SEN} is coupled across the third switching device Q₃, and is configured to generate a second sensed current I_{3_SNS} related to the current through the third switching device Q₃.

The first and second sensed currents I_{2_SNS} and I_{3_SNS} are summed by a current summer 660 to generate a sensed inductor current I_{L_SNS} (e.g., related to or substantially the same as the inductor current I_{L}) to generate a control signal or voltage V_{L_SNS} for a master/slave charger across a resistor R_{L}.

The upper-right and lower-right graphs of FIG. 6B illustrate how the inductor current is sensed via the first and second sensed current I_{2_SNS} and I_{3_SNS}. The upper-right graph pertains to the case where the ratio (D) of the output voltage Vₒ to the input voltage Vᵢₙ is less than 0.5. The lower-right graph pertains to the case where the ratio (D) of the output voltage Vₒ to the input voltage Vᵢₙ is greater than 0.5. The horizontal axis represents time.

The upper-graph explains that the first sensed current I_{2_SNS} is substantially the same as the left portion of the inductor current I_{L}, and the second sensed current I_{3_SNS} is substantially the same as the right (highlighted) portion of the inductor current I_{L}. Thus, summing the first and second sensed currents I_{2_SNS} and I_{3_SNS} by the summer 660 generates the entire sensed inductor current I_{L_SNS}. Similarly, the lower-graph explains that the first sensed current I_{2_SNS} is substantially the same as the left portion of the inductor current I_{L}, and the second sensed current I_{3_SNS} is substantially the same as the right (highlighted) portion of the inductor current I_{L}. Thus, summing the first and second sensed currents I_{2_SNS} and I_{3_SNS} by the summer 660 generates the entire sensed inductor current I_{L}.

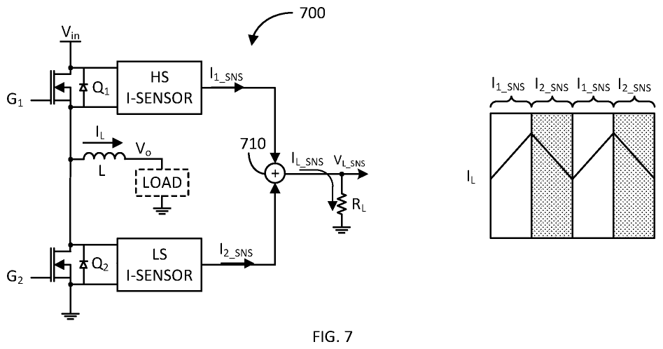

FIG. 7 illustrates a schematic diagram of another exemplary two-level Buck converter 700 with high-side (HS) and low-side (LS) switching devices current sensors HS_{SEN} and LS_{SEN} in accordance with another aspect of the disclosure. The HS current sensor HS_{SEN} is coupled across the first switching device Q₁, and is configured to generate a first sensed current I_{1_SNS} related to the current through the first switching device Q₁. The LS current sensor LS_{SEN} is coupled across the second switching device Q₂, and is configured to generate a second sensed current I_{1_SNS} related to the current through the second switching device Q₂.

The first and second sensed currents I_{1_SNS} and I_{2_SNS} are summed by a current summer 710 to generate a sensed inductor current I_{L_SNS} (e.g., related to or substantially the same as the inductor current) to generate a control signal or voltage V_{L_SNS} for a master/slave charger across a resistor R_{L}.

The graph of FIG. 7 illustrates how the inductor current I_{L} is sensed via the first and second sensed current I_{1_SNS} and I_{2_SNS}. The graph explains that the first sensed current I_{1_SNS} is substantially the same as the first left and third portions from the left of the inductor current I_{L}, and the second sensed current I_{1_SNS} is substantially the same as the second and fourth portion from the left of the inductor current I_{L}. Thus, summing the first and second sensed currents I_{1_SNS} and I_{2_SNS} by the summer 710 generates the entire sensed inductor current for the Buck converter 700 for control purposes.

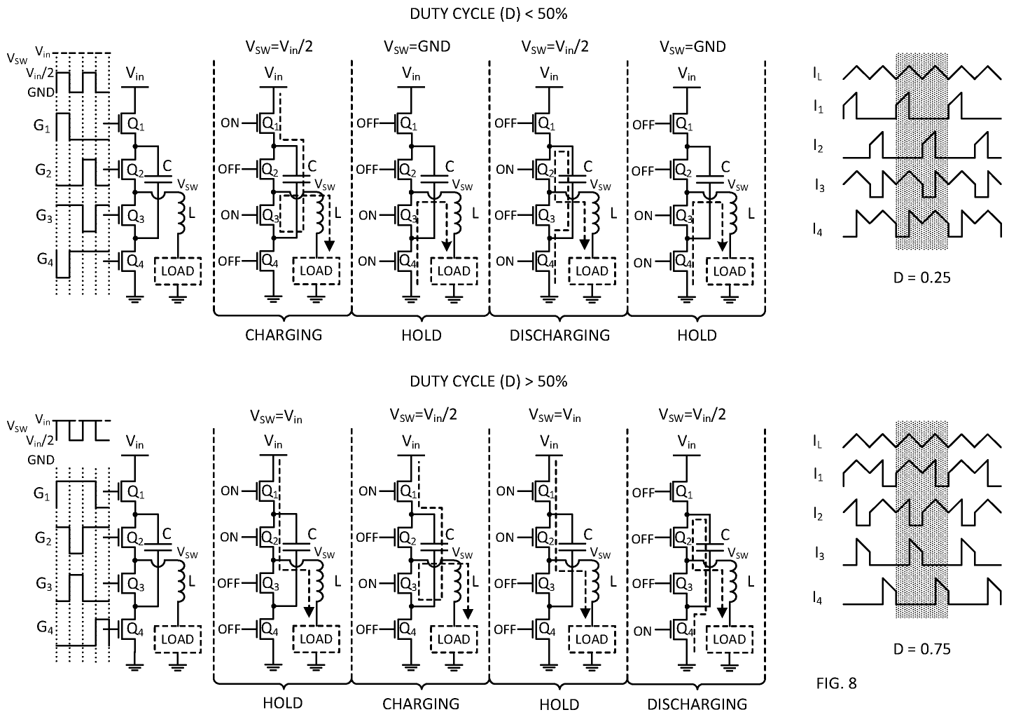

FIG. 8 illustrates a schematic diagram of another exemplary three-level Buck converter in Vₒ/Vᵢₙ<0.5 and Vₒ/Vᵢₙ>0.5 switching modes with high-side and low-side switching devices current sensing in accordance with another aspect of the disclosure. The top graph represents when a three-level Buck converter is operated in Vₒ/Vᵢₙ<0.5 mode, and the bottom graph represents when a three-level Buck converter is operated in Vₒ/Vᵢₙ>0.5 mode.

With reference to the graphs on the upper-right, depicting from top-to-bottom, the inductor current I_{L}, the current I₁ through switching device Q₁, the current I₂ through switching device Q₂, the current I₃ through switching device Q₃, and the current I₄ through switching device Q₄, it is noted that the inductor current I_{L} can be reconstructed by summing the first and the fourth currents I₁ and I₄ (e.g., I_{L}=I₁+I₄). In addition, it is also noted that the inductor current I_{L} can be reconstructed by summing the second and the third currents I₂ and I₃ (e.g., I_{L}=I₂+I₃). The same is true for when the Buck converter is operated in Vₒ/Vᵢₙ>0.5 as shown in the lower graph.

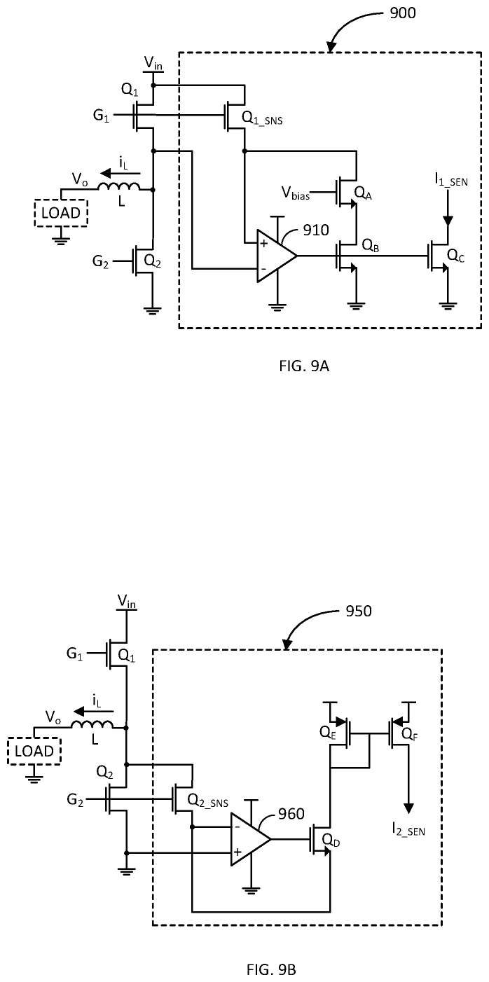

FIG. 9A illustrates a schematic diagram of an exemplary high-side switching device current sensor 900 for a Buck converter in accordance with another aspect of the disclosure. The high-side current sensor 900 includes a sensing FET Q_{1_SNS} including drain and gate coupled to drain and gate of the high-side switching device Q₁, respectively. The source voltages of FETs Q₁ and Q_{1_SNS} are applied to negative and positive inputs of a differential amplifier 910, respectively. The differential amplifier 910 generates a gate voltage for FETs Q_{B} and Q_{C} of a current mirror configuration. Through negative feedback via FETs Q_{A} and Q_{B}, the differential amplifier 910 forces the source voltages of the FETs Q₁ and Q_{1_SNS} to be substantially the same. Thus, the current through Q_{1_SNS}, and consequently through FETs Q_{A} and Q_{B} is related to (e.g., substantially the same or a defined ratio of) the current through FET Q₁. Accordingly, one of the current-mirror FETs QC generates an I_{1_SEN} current related to the current through the high-side switching device Q₁. A bias voltage Vbias is applied to the gate of FET Q_{A}, which serves as an over-voltage protection device for FET Q_{B}.

FIG. 9B illustrates a schematic diagram of an exemplary low-side switching device current sensor 950 for a Buck converter in accordance with another aspect of the disclosure. The low-side current sensor 950 includes a sensing FET Q_{2_SNS} including gate and source coupled to gate and source of the low-side switching device Q₂, respectively. The source voltages of FETs Q₂ and Q_{2_SNS} are applied to positive and negative inputs of a differential amplifier 960, respectively. The differential amplifier 960 generates a gate voltage for FET Q_{D}, whose source is also coupled to the negative input of the differential amplifier. Through negative feedback, the differential amplifier 960 forces the source voltages of the FETs Q₂ and Q_{2_SNS} to be substantially the same. Thus, the current through FET Q_{D} is related to (e.g., substantially the same or a defined ratio of) the current through FET Q₂. The current through FET Q_{D} also flows through FET Q_{E}, which is in a current mirror configuration with FET Q_{F}. Accordingly, the current-mirror FET Q_{F} generates an I_{2_SEN} current related to the current through the low-side switching device Q₂.

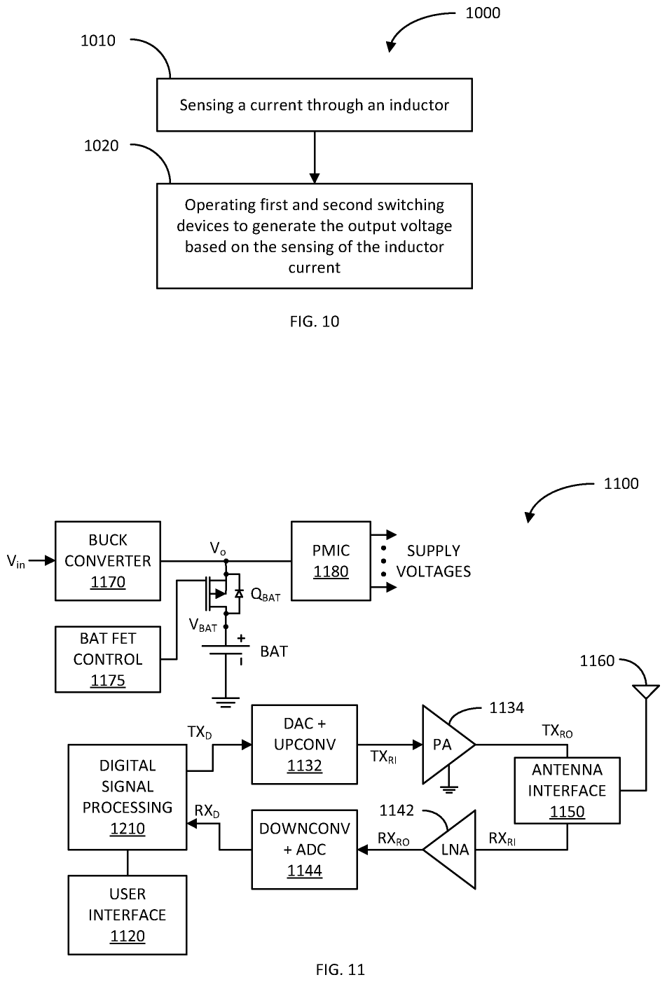

FIG. 10 illustrates a flow diagram of an exemplary method 1000 of generating an output voltage across a load. The method 1000 includes sensing a current through an inductor (block 1010). An example of means for sensing a current through an inductor includes any of the current sensors described herein.

The method 1000 further includes operating first and second switching devices to generate the output voltage based on the sensing of the inductor current. (block 1020). An example of means for operating first and second switching devices to generate the output voltage based on the sensing of the inductor current includes any of the controllers described herein.

FIG. 11 illustrates a block diagram of an exemplary wireless device 1100 in accordance with another aspect of the disclosure. The Buck converters described herein may be used in wireless device applications.

For instance, the wireless device 1100 includes a digital signal processing core 1110; a user interface 1120; a radio frequency (RF) transmitter including digital-to-analog (DAC)+upconverter 1132 and a power amplifier (PA) 1134; an RF receiver including a low noise amplifier (LNA) 1142, and a downconverter+analog-to-digital converter (ADC) 1144; an antenna interface 1150 (e.g., a diplexer); and an antenna 1160. The wireless device 1100 further includes a Buck converter 1170, a battery (BAT), a BAT FET Q_{BAT}, a BAT FET control 1175, and a power management integrated circuit (PMIC) 1180.

Based on signals exchanged between the digital signal processing core 1110 and the user interface 1120, the digital signal processing core 1110 may generate a transmit digital signal TX_{D}. The DAC+upconverter 1132 generates an input transmit RF signal TX_{RI} by converting the transmit digital signal TX_{D} into an analog signal and frequency upconverting the analog signal. The PA 1134 amplifies the input transmit RF signal TX_{RI} to generate an output transmit RF signal TX_{RO}. The output transmit RF signal TX_{RO} is sent to the antenna 1160 via the antenna interface 1150 for transmission to one or more other wireless devices via a wireless medium.

The LNA 1142 may receive an input receive RF signal RX_{RI} from one or more other wireless devices via the antenna 1160 and the antenna interface 1150. The LNA 1142 amplifies the input receive RF signal RX_{RI} to generate an output receive RF signal RX_{RO}. The downconverter+ADC 1144 generates a receive digital signal RX_{D} by frequency downconverting the output received RF signal RX_{RO} to generate an analog signal and convert the analog signal into a digital signal. The digital signal processing core 1110 receives the receive digital signal RX_{D}. The digital signal processing core 1110 may process the receive digital signal RX_{D} based on signals exchanged between the digital signal processing core 1110 and the user interface 1120.

The Buck converter 1170 may receive an external input voltage Vᵢₙ. As an example, the external input voltage Vᵢₙ may have been generated by a Universal Serial Bus (USB) charger, a wireless charger, a transformer-rectifier plugged into an outlet, or other external voltage source. As discussed with reference to the various Buck converters described herein, the Buck converter 1170 generates an output voltage Vₒ based on the input voltage Vᵢₙ. The battery is an example of a load for the Buck converter 1170. The output voltage Vₒ provides charging current to the battery via the BAT FET Q_{BAT}. The BAT FET control 1175 controls the gate of the BAT FET Q_{BAT} on or off. The BAT FET Q_{BAT} also senses the current that goes into the battery when charging, so that the Buck converter can regulate Vₒ to provide a regulated battery current into the battery. The output voltage Vₒ is provided to the PMIC 1180 for generating a set of supply voltages for the wireless device 1100, such as to provide power to the components 1110 through 1150 of the wireless device.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus for generating an output voltage across a load, comprising:
a first charger, comprising:
a first switching device;
a second switching device coupled in series with the first switching device between an upper voltage rail and a lower voltage rail, wherein the upper voltage rail is configured to receive an input voltage;
a first inductor coupled between a node between the first and second switching devices and the load;
a first sensor configured to generate a first control signal related to a current through the first inductor, wherein the first sensor comprises:
a first current sensor configured to generate a first sensed current related to a current through the first switching device;
a second current sensor configured to generate a second sensed current related to a current through the second switching device; and
a first summer configured to sum the first and second sensed currents to generate the first control signal; and
at least one controller configured to operate the first and second switching devices to generate the output voltage based on the first control signal.

2. The apparatus of claim 1, wherein the first switching device includes a terminal coupled to the upper voltage rail, and wherein the second switching device includes a terminal coupled to the lower voltage rail.

3. The apparatus of claim 2, further comprising third and fourth switching devices coupled in series between the first and second switching devices.

4. The apparatus of claim 1, further comprising a third switching device coupled between the upper voltage rail and the first switching device, and a fourth switching device coupled between the second switching device and the lower voltage rail.

5. The apparatus of claim 1, further comprising a second charger comprising:
a third switching device;
a fourth switching device coupled in series with the third switching device between the upper voltage rail and the lower voltage rail;
a second inductor coupled between a node between the third and fourth switching devices and the load; and
a second sensor configured to generate a second control signal related to a current through the second inductor, wherein the at least one controller is configured to operate the third and fourth switching devices to generate the output voltage based on the second control signal.

6. The apparatus of claim 5, wherein the second sensor comprises:
a third current sensor configured to generate a third sensed current related to a current through the third switching device;
a fourth current sensor configured to generate a fourth sensed current related to a current through the fourth switching device; and
a second summer configured to sum the third and fourth sensed currents to generate the second control signal.

7. The apparatus of claim 5, further comprising fifth and sixth switching devices coupled in series between the third and fourth switching devices.

8. The apparatus of claim 5, further comprising a fifth switching device coupled between the upper voltage rail and the third switching device, and a sixth switching device coupled between the second switching device and the lower voltage rail.

9. A method for generating an output voltage across a load, comprising:
sensing a current through a first inductor, comprising:
sensing a first current through a first switching device;
sensing a second current through a second switching device; and
summing the first and second sensed currents to generate the sensed current through the first inductor; and
operating the first switching device and the second switching device to generate the output voltage based on the sensing of the current through the first inductor.

10. The method of claim 9, wherein the first switching device includes a terminal coupled to an upper voltage rail, and wherein the second switching device includes a terminal coupled to the lower voltage rail.

11. The method of claim 10, further comprising third and fourth switching devices coupled in series between the first and second switching devices.

12. The method of claim 9, further comprising a third switching device coupled between an upper voltage rail and the first switching device, and a fourth switching device coupled between the second switching device and a lower voltage rail.

13. The method of claim 9, further comprising:
sensing a current through a second inductor; and
operating a third switching device and a fourth switching device to generate the output voltage based on the sensing of the current through the second inductor.

14. The method of claim 13, wherein sensing the current through the second inductor comprises:
sensing a third current through the third switching device;
sensing a fourth current through the fourth switching device; and
summing the third and fourth sensed currents to generate the sensed current through the second inductor.

15. An apparatus for generating an output voltage across a load, comprising:
means for sensing a current through a first inductor, comprising:
means for sensing a first current through a first switching device;
means for sensing a second current through a second switching device; and
means for summing the first and second sensed currents to generate the sensed current through the first inductor; and
means for operating first and second switching devices to generate the output voltage based on the sensing of the current through the first inductor.

16. The apparatus of claim 15, wherein the first switching device includes a terminal coupled to an upper voltage rail, and wherein the second switching device includes a terminal coupled to the lower voltage rail.

17. The apparatus of claim 16, further comprising third and fourth switching devices coupled in series between the first and second switching devices.

18. The apparatus of claim 15, further comprising a third switching device coupled between an upper voltage rail and the first switching device, and a fourth switching device coupled between the second switching device and a lower voltage rail.

19. The apparatus of claim 15, further comprising:
means for sensing a current through a second inductor; and
means for operating a third switching device and a fourth switching device to generate the output voltage based on the sensing of the current through the second inductor.

20. The apparatus of claim 19, wherein the means for sensing the current through the second inductor comprises:
means for sensing a third current through the third switching device;
means for sensing a fourth current through the fourth switching device; and
means for summing the third and fourth sensed currents to generate the sensed current through the second inductor.
